(19) United States
(12) Patent Application Publication
(10) Pub. No.: US 2007/0268793 A1
(43) Pub. Date: Nov. 22, 2007

(54) Optical recording medium drive and optical pickup

(75) Inventor: Wataru Niibe, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/529,835

(22) Filed: Sep. 29, 2006

(30) Foreign Application Priority Data
May 19, 2006 (JP) 2006-140777

(51) Int. Cl. G11B 7/00; G11B 33/12

(52) U.S. Cl. 369/44.14; 720/652

(57) ABSTRACT

An optical recording medium drive allows a support body to define a hollow space having the inner end and the outer end defining an optical opening. The hollow space is surrounded by the inside surface of the support body. A shielding plate serves to screen or close the hollow space at a position distanced from the optical opening. The reflecting mirror is opposed to the inner end of the hollow space. Dust penetrates into the optical recording medium drive through any gap in the enclosure of the optical recording medium drive. Even if dust enters the hollow space, the shielding plate serves to prevent the dust to fly toward the reflecting mirror out of the hollow space. The dust is prevented from adhering to the reflecting mirror. Since the shielding plate is located at a position distanced from the optical opening, dust hardly reaches and adheres to the shielding plate.

### BACKGROUND OF THE INVENTION

1. Field of the Invention

The present invention relates to an optical recording medium drive including: an optical recording medium such as a magneto-optical disk; and an optical pickup capable of performing a read/write operation of data.

2. Description of the Prior Art

An optical pickup is incorporated in an optical disk drive as disclosed in Japanese Patent Application Publication No. 4-11333, for example. The optical pickup includes a casing designed to move in parallel with the surface of an optical disk. A reflecting mirror is located within the casing. An objective lens is located in a space between the reflecting mirror and the optical disk. The reflecting mirror and the objective lens serve to direct a laser beam from a light source to the optical disk. The reflecting mirror also serves to direct the laser beam returning from the optical disk to a detector. Data is in this manner read out, for example.

An optical opening is defined in the casing. A shielding plate or glass plate is fitted in the optical opening. The glass plate serves to block dust from entering the casing, when airflow is generated during the rotation of the optical disk. However, the glass plate is exposed at the outside surface of the casing. Dust inevitably adheres to the glass plate. Taint on the glass plate causes a reduction in the luminous energy of the laser beam. Data cannot be written or read with accuracy.

### SUMMARY OF THE INVENTION

It is accordingly an object of the present invention to provide an optical recording medium drive and an optical pickup reliably preventing a shielding plate from suffering from taint.

According to the present invention, there is provided an optical recording medium drive comprising: a support body defining a hollow space along the inside surface of the support body, the hollow space having the inner end and the outer end that defines an optical opening; a reflecting mirror supported on the support body, the reflecting mirror opposed to the inner end of the hollow space; and a transparent shielding plate screening the hollow space at a position distanced from the optical opening.

The optical recording medium drive allows the support body to define the hollow space having the inner end and the outer end defining the optical opening. The hollow space is surrounded by the inside surface of the support body. The shielding plate serves to screen or close the hollow space at a position distanced from the optical opening. The reflecting mirror is opposed to the inner end of the hollow space. Dust penetrates into the optical recording medium drive through any gap in the enclosure of the optical recording medium drive, for example. However, even if dust enters the hollow space, the shielding plate serves to prevent the dust to fly toward the reflecting mirror out of the hollow space. The dust is prevented from adhering to the reflecting mirror. Furthermore, the shielding plate is located at a position distanced from the optical opening. The dust hardly reaches and adheres to the shielding plate. The shielding plate can be prevented from suffering from taint.

The optical recording medium drive may further comprise: a support member located within a space surrounded by the inside surface of the support body at a position distanced from the inside surface of the support body; an objective lens supported on the support member, the objective lens opposed to the reflecting mirror within the space; and a leaf spring coupling the support member to the support body for a movement relative to the support body.

The support member is located in the space defined in the support body at a position distanced from the inside surface of the support body in the optical recording medium drive. The objective lens is located on the support member. The leaf spring serves to couple the support member to the support body for a movement relative to the support body. A predetermined gap is defined between the support body and the support member. The shielding plate serves to screen or close the aforementioned hollow space. Even if airflow is generated within the optical recording medium drive, it is possible to prevent the airflow from running through the hollow space toward a space containing the objective lens. Even if dust is caught in the airflow, the airflow or dust is prevented from entering the hollow space.

The optical recording medium drive may further comprise: an optical recording medium; a rail extending in parallel with the surface of the optical recording medium; and a through hole defined in the support body for receiving the rail. The through hole forms a sliding bearing.

A specific optical pickup is provided to realize the optical recording medium drive. The optical pickup may comprise: a support body defining a hollow space along the inside surface of the support body, the hollow space having the inner end and the outer end that defines an optical opening; a reflecting mirror supported on the support body, the reflecting mirror opposed to the inner end of the hollow space; and a transparent shielding plate screening the hollow space at a position distanced from the optical opening.

Likewise, the optical pickup may further comprise: a support member located within a space surrounded by the inside surface of the support body at a position distanced from the inside surface of the support body; an objective lens supported on the support member, the objective lens opposed to the reflecting mirror within the space; and a leaf spring coupling the support member to the support body for a movement relative to the support body. The support body may define a through hole receiving a rail extending straight. The through hole forms a sliding bearing.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a front view schematically illustrating a computer as a specific example of an electronic apparatus according to the present invention;

FIG. 2 is a sectional view taken along the line 2-2 in FIG. 1;

FIG. 3 is a plan view schematically illustrating the structure of a magneto-optical disk drive;

FIG. 4 is a side view schematically illustrating the structure of the magneto-optical disk drive;

FIG. 5 is an enlarged partial plan view schematically illustrating the structure of a mobile unit;

FIG. 6 is a sectional view schematically illustrating the structure of the mobile unit;

FIG. 7 is a rear view schematically illustrating the structure of the mobile unit; and

FIG. 8 is a graph showing a relationship between a luminous energy and an elapsed time.

### DESCRIPTION OF THE PREFERRED EMBODIMENT

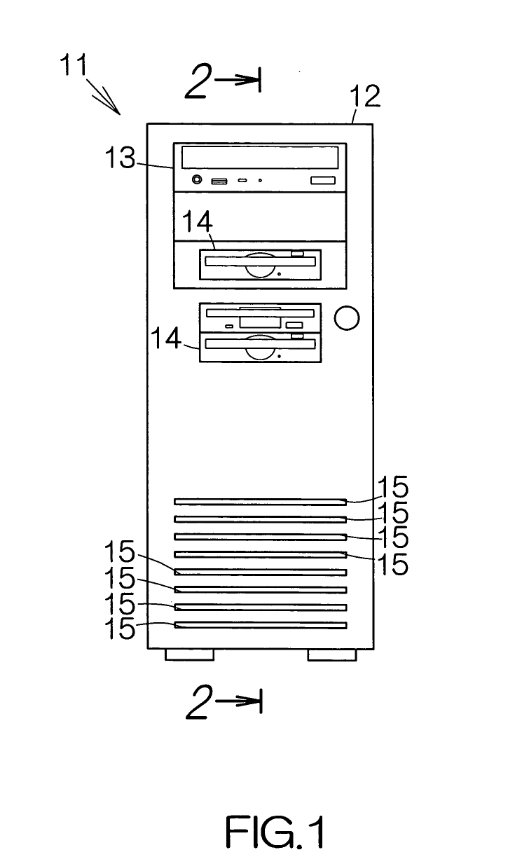

FIG. 1 schematically illustrates a computer 11 as an example of an electronic apparatus according to the present invention. A display device, not shown, is connected to the computer 11. The computer 11 and the display device in combination establish a so-called desktop computer system. An input device or devices such as a keyboard and/or a mouse, not shown, are further connected to the computer 11, for example.

The computer 11 includes a box-shaped enclosure 12. Optical recording medium drives such as a DVD-ROM drive 13 and a magneto-optical disk drive or drives 14 are embedded in the front panel of the enclosure 12, for example. The DVD-ROM drive 13 defines a slot in its front panel to accept the insertion of a DVD-ROM disk. The DVD-ROM drive 13 is designed to read out data from the inserted DVD-ROM disk. The individual magneto-optical disk drive 14 likewise defines a slot in its front panel to accept the insertion of a MO (magneto-optical) cartridge, for example. The magneto-optical disk drive 14 is designed to write data onto an optical recording medium or MO disk within the inserted MO cartridge. The magneto-optical disk drive 14 is also designed to read out data from the MO disk. Air inlets 15 are defined in the front panel of the enclosure 12.

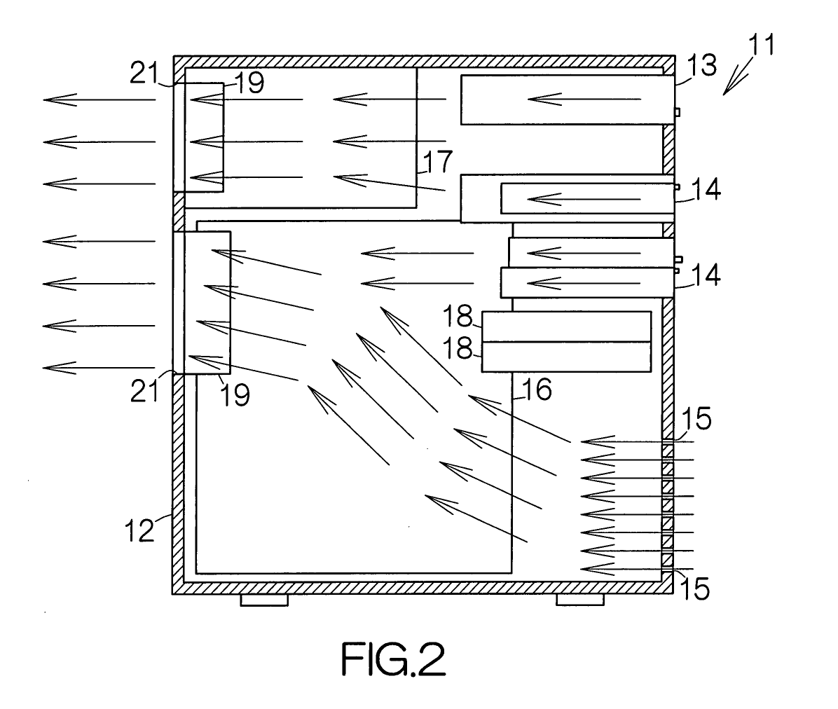

As shown in FIG. 2, a so-called motherboard 16 and a power source unit 17 are enclosed in the enclosure 12. Electronic circuit elements such as a central processing unit (CPU), a memory, and the like, are mounted on the motherboard 16, for example. The CPU executes various kinds of processing based on software programs and/or data temporarily held in the memory, for example. The software programs and/or data may be stored in a mass storage such as a hard disk drive (HDD) 18 likewise enclosed in the enclosure 12. A user can manipulate the keyboard and/or the mouse to input various kinds of data and/or instructions to the CPU.

A pair of fans 19, 19 is embedded in the back panel of the enclosure 12, for example. The fans 19 are opposed to air outlets 21 defined in the back panel of the enclosure 12, respectively. The rotation of the rotors of the fans 19 forces a fresh air to enter the enclosure 12 through not only the air inlets 15 but also any gap in the enclosure 12. For example, a gap or gaps in the front of the magneto-optical disk drive or drives 14 function as an inlet for a fresh air. The airflow runs within the enclosure 12 along a path from the front toward the back of the enclosure 12. The airflow runs along the motherboard 16 and the power source unit 17. The airflow absorbs heat from the motherboard 16, the electronic circuit elements and the power source unit 17. The airflow is then discharged out of the enclosure 12 through the air outlets 21.

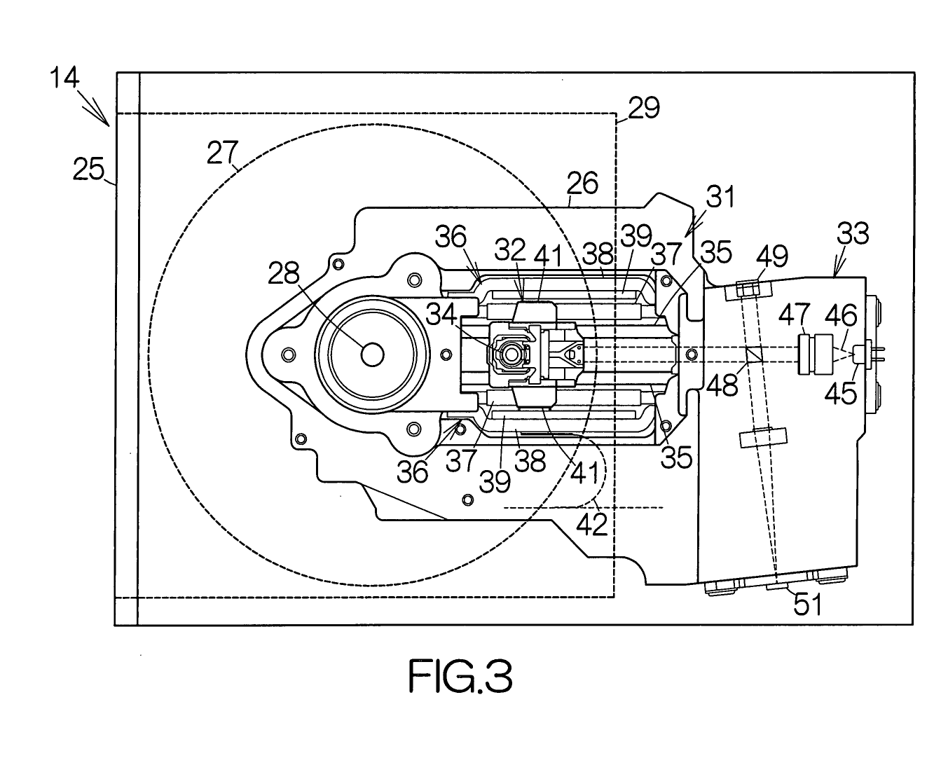

FIG. 3 schematically illustrates the structure of the magneto-optical disk drive 14. The magneto-optical disk drive 14 includes a casing 25. A base 26 is incorporated in the casing 25. The base 26 is received on the bottom plate of the casing 25, for example. A spindle motor 28 is assembled in the base 26. The spindle motor 28 is designed to support a MO disk 27. The spindle motor 28 drives the MO disk 27 for rotation around the longitudinal axis of the spindle motor 28. The MO disk 27 is thus in this case allowed to rotate in the clockwise direction. The MO disk 27 is held in a MO cartridge 29. The MO cartridge 29 is inserted through a slot defined in the front panel of the casing 25.

An optical pickup 31 is assembled in the base 26. The optical pickup 31 includes a mobile unit 32 and a stationary unit 33. The optical pickup 31 is a so-called separated type optical pickup. An objective lens 34 is embedded in the mobile unit 32. The objective lens 34 is opposed to the back surface of the MO disk 27. The mobile unit 32 is supported on a pair of rails 35, 35 extending straight along the back surface of the MO disk 27. The individual rail 35 is formed in the shape of a column, for example. The rails 35 are designed to extend in parallel with each other in the radial direction of the MO disk 27 from the longitudinal axis of the spindle motor 28. The mobile unit 32 is thus allowed to move on the radial line of the MO disk 27.

Magnetic circuits 36 are incorporated in the optical pickup 31 for realization of the straight movement of the mobile unit 32. The magnetic circuits 36 individually include an inner yoke 37 and an outer yoke 38. The inner yoke 37 extends in parallel with the rails 35 at a position outside the rails 35. The outer yoke 38 extends in parallel with the inner yoke 37 at a position outside the inner yoke 37. The opposite ends of the outer yoke 38 are connected to the opposite ends of the inner yoke 37, respectively. The magnetic circuits 36 individually include a permanent magnet 39. The permanent magnet 39 is fixed to the outer yoke 38 at the side surface opposed to the inner yoke 37. The permanent magnet 39 serves to generate magnetic fluxes circulating through the inner and outer yokes 37, 38.

The magnetic circuits 36 individually include a coil 41 wound around the inner yoke 37. The coils 41 are set on the opposite sides of the mobile unit 32, respectively. A predetermined gap is defined between the coil 41 and the corresponding inner yoke 37. A driving force is generated in a direction parallel to the rails 35 in response to the supply of electric current to the coils 41 in the magnetic fields of the magnetic circuits 36. The driving force enables the movement of the mobile unit 32 along the rails 35. The adjustment of the electric current supplied to the coils 41 enables a control on the amount of the movement of the mobile unit 32 along the rails 35.

A flexible printed circuit board 42 is utilized for the supply of the electric current. One end of the flexible printed circuit board 42 is connected to the mobile unit 32. The flexible printed circuit board 42 curves and extends within the base 26. The other end of the flexible printed circuit board 42 may be attached to a metallic attachment piece, not shown, fixed to the base 26. The electric current may be supplied to the flexible printed circuit board 42 from a printed circuit board, not shown, located within the inner space of the casing 25. A detailed description will later be made on the mobile unit 32.

The stationary unit 33 includes a light source such as a laser diode 45. The laser diode 45 is designed to emit a light beam or laser beam 46. The laser beam 46 is directed to a collimator 47. The collimator 47 is designed to convert the laser beam 47 into parallel rays. The laser beam 46 is then directed toward the rear end of the mobile unit 32. A beam splitter 48 is located in a space between the collimator 47 and the mobile unit 32. The laser beam 46 from the laser diode 45 passes through the beam splitter 48.

A reflecting mirror, not shown, is disposed in the mobile unit 32 to direct the laser beam 46 to the objective lens 34. The reflecting mirror will later be described in detail. The laser beam 46 is then irradiated onto the back surface of the MO disk 27. The objective lens 34 forms a minute beam spot on the back surface of the MO disk 27. The laser beam 46 is reflected from a reflection film of the MO disk 27. The laser beam 46 thus returns from the MO disk 27 to the objective lens 34. The reflecting mirror then directs the laser beam 46 from the objective lens 34 to the beam splitter 48.

A data detector 49 and an APC (automatic power control) detector 51 are opposed to the beam splitter 48. The data detector 49 may also function as a servo detector, for example. The beam splitter 48 directs the laser beam 46 to the data detector 49 and the APC detector 51. The data detector 49 and the APC detector 51 are designed to detect the laser beam 46. The laser beam 46 is converted into electric signals. The electrical signals are supplied to a controlling circuit on the aforementioned printed circuit board, for example. Data is in this manner read out from the MO disk 27.

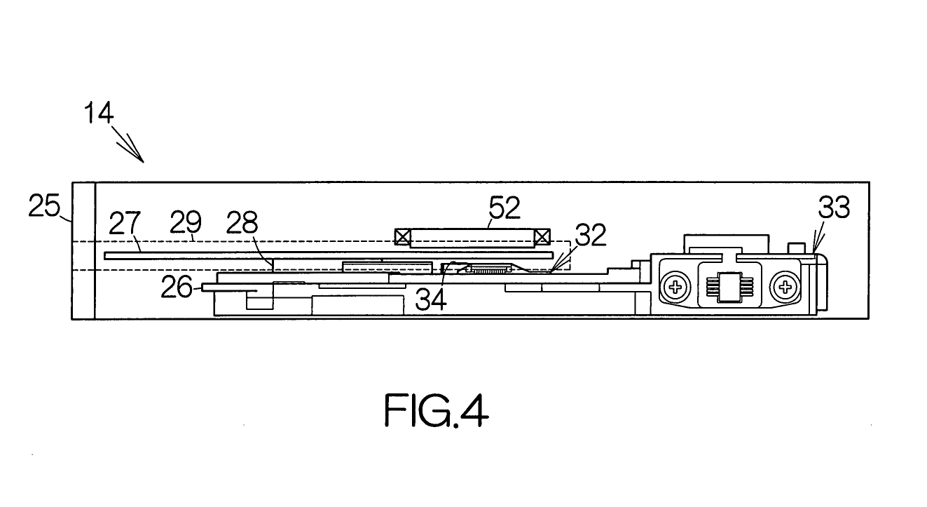

As shown in FIG. 4, a biasing magnet 52 is opposed to the objective lens 34 of the mobile unit 32. The biasing magnet 52 may be located on the extension of the path of the laser beam 46 directed from the objective lens 34 toward the MO disk 27. The irradiated laser beam 46 induces a rise in the temperature of a magnetic recording film of the MO disk 27. The magnetic recording film is subjected to a magnetic field for recordation from the biasing magnet 52. The rise in the temperature allows the magnetization to rotate in the magnetic recording film in response to the direction of the magnetic field for recordation. Data is in this manner written onto the magnetic recording film.

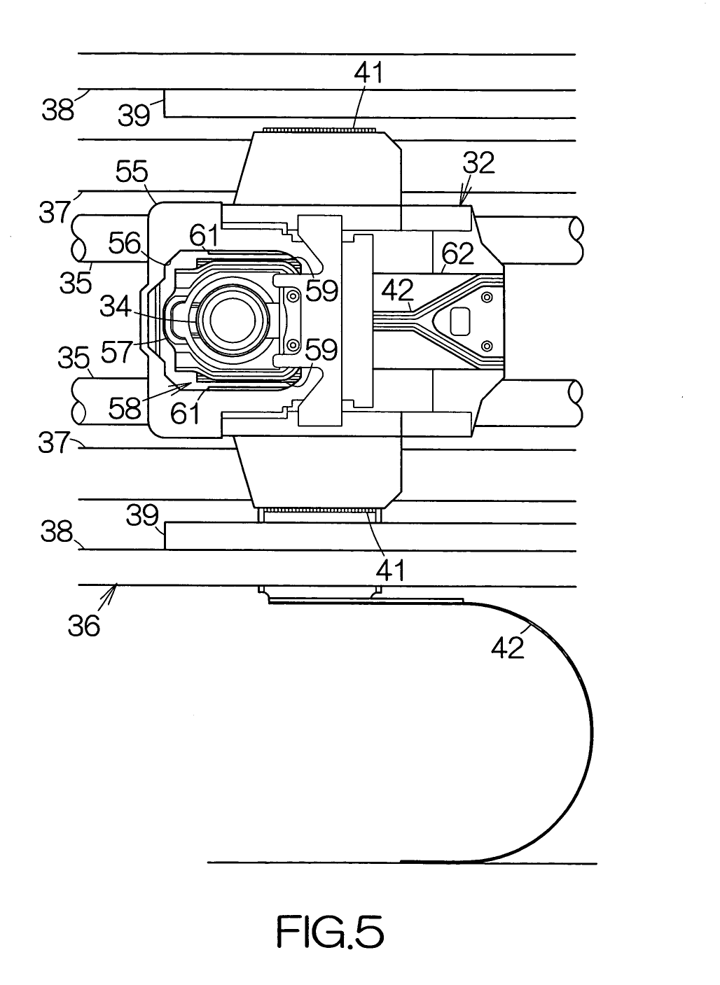

As shown in FIG. 5, the mobile unit 32 includes a support body 55 made of a resin material, for example. The support body 55 has the shape similar to a rectangular parallelepiped. The support body 55 is supported on the aforementioned rails 35, 35. An opening 56 is defined in the upper surface of the support body 55. The upper surface of the support body 55 is opposed to the back surface of the MO disk 27. The aforementioned objective lens 34 is located in the opening 56. The objective lens 34 is supported on a support member 57. A predetermined space is determined between the edge of the opening 56 and the outer periphery of the support member 57. A magnetic circuit 58 is incorporated in the support body 55. The magnetic circuit 58 includes coils 59, 59 and permanent magnets 61, 61. The coils 59, 59 are fixed to the opposite sides of the support member 57, respectively. The permanent magnets 61, 61 are opposed to the corresponding coils 59, 59, respectively. The permanent magnets 61 may be fixed to the inside surface of the support body 55.

A pair of leaf springs 62, 62 is utilized to couple the support member 57 to the support body 55. The leaf springs 62 allow a movement of the support member 57 relative to the support body 55. The leaf springs 62 may extend in parallel with the front and back surfaces of the MO disk 27, as shown in FIG. 6. The support member 57 is interposed between the leaf springs 62, 62 in the vertical direction. The coils 59 are designed to generate magnetic flux in response to the supply of electric current. Magnetic flux is likewise generated in the permanent magnets 61. The magnetic fluxes of the coils 59 act on the magnetic fluxes of the permanent magnets 61 so as to cause the vertical movement of the support body 55. The objective lens 34 is thus allowed to get closer to or distanced from the back surface of the MO disk 27. The objective lens 34 is in this manner subjected to focus. The aforementioned flexible printed circuit board 42 may be utilized for the supply of electric current.

The support body 55 defines a horizontal hollow space 63 extending in parallel with the rails 53, 53. The horizontal hollow space 63 extends in the longitudinal direction of the support body 55 along a plane perpendicular to the optical axis of the objective lens 34. The horizontal hollow space 63 is surrounded by the inside surface of the support body 55. The horizontal hollow space 63 has the inner and outer ends. The outer end defines an optical opening 64. A shielding plate 65 is located in the support body 55 at a position distanced from the optical opening 64. Here, the shielding plate 65 screens or closes the horizontal hollow space 63 at the inner end of the horizontal hollow space 63. A transparent glass plate may be employed as the shielding plate 65, for example. The front and back surfaces of the shielding plate 65 may be inclined by a predetermined inclination angle from a plane intersecting with the aforementioned optical axis at right angles.

A reflecting mirror 66 is supported on the support body 55 on the optical axis of the objective lens 34. The reflecting mirror 66 is set in a predetermined attitude inclined from a plane perpendicular to the optical axis of the objective lens 34. The reflecting mirror 66 has a reflecting surface 67 opposed to the objective lens 34 and the shielding plate 65. A vertical hollow space 68 is defined in the support body 55. The vertical hollow space 68 has the inner end opposed to the reflecting mirror 66 and the outer end defining the aforementioned opening 56. The vertical hollow space 68 is surrounded by the inside surface of the support body 55. The objective lens 34 is opposed to the reflecting mirror 66 in the vertical hollow space 68. The support member 57 is distanced from the inside surface of the support body 55. The reflecting surface 67 is designed to reflect the laser beam 46 from the optical opening 64 to the objective lens 34. The reflecting mirror 67 is also designed to reflect the laser beam 46 from the objective lens 34 to the optical opening 64.

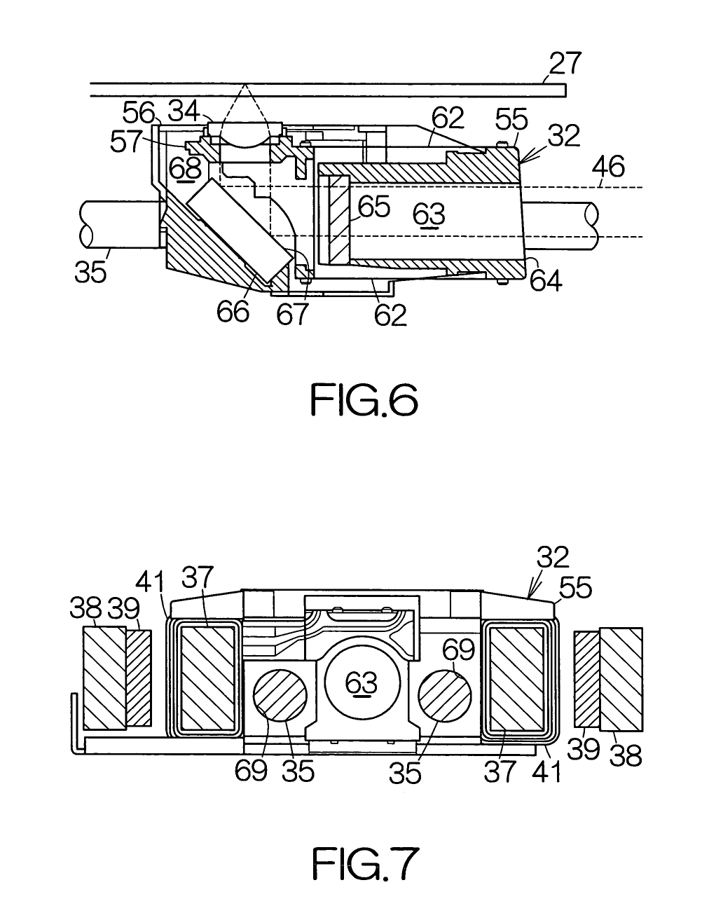

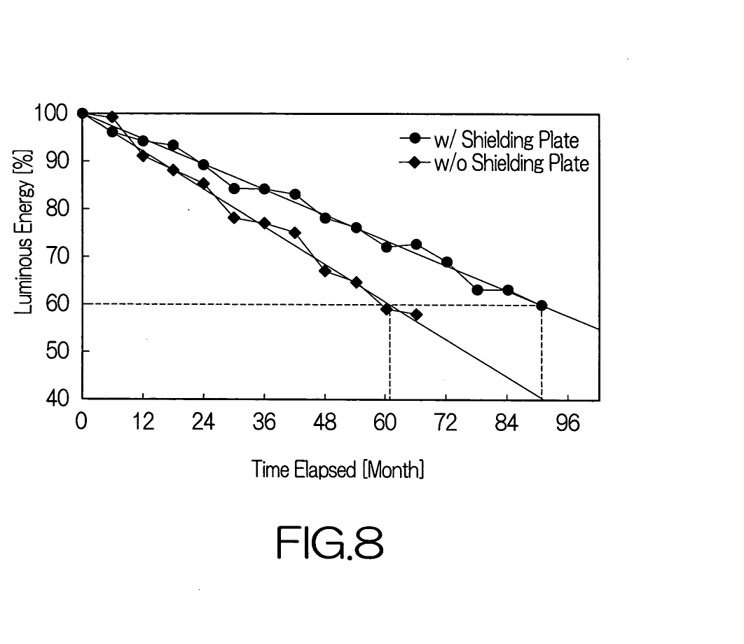

As shown in FIG. 7, through holes 69 are defined in the support body 55 at the opposite sides of the horizontal hollow space 63, respectively. The through holes 69 are designed to receive the rails 35, respectively. The through holes 69 individually function as a sliding bearing. The through holes 69 extend in the longitudinal direction of the support body 55. The individual through hole 69 may have a circular cross-section, for example. Grease is applied to the surfaces of the rails 35, for example. The grease serves to reduce the friction between the rails 35 and the corresponding through holes 69. The horizontal hollow space 63 may have a circular cross-section, for example. The inner yoke 37 may have a rectangular cross-section, for example.

Now, assume that data is to be read out from the MO disk 27. The spindle motor 28 drives the MO disk 27 for rotation. The mobile unit 32 is driven to move straight in the radial direction of the MO disk 27. The laser diode 45 emits the laser beam 46. The data detector 49 and the APC detector 51 detect the laser beam 46 returning from the MO disk 27 as described above. The objective lens 34 is in this manner positioned right on a predetermined track. Data is then read out.

Airflow is generated along the front and back surfaces of the MO disk 27 during the rotation of the MO disk 27. When airflow is generated in the computer 11, dust penetrates into the casing 25 through any gap of the casing 25. Such dust is caught in the airflow in the casing 25. On the other hand, the shielding plate 65 closes the inner end of the horizontal hollow space 63 in the mobile unit 32. The shielding plate 65 serves to disconnect the vertical hollow space 68 from the horizontal hollow space 63. This disconnection enables the avoidance of airflow entering the horizontal hollow space 63. Dust is reliably prevented from entering the horizontal hollow space 63. Furthermore, the shielding plate 65 is distanced from the optical opening 64. Even if dust enters the horizontal hollow space 63, the dust hardly reaches the shielding plate 65. No dust adheres to the surface of the shielding plate 65. The shielding plate 65 is prevented from suffering from taint. Simultaneously, no dust adheres to the reflecting surface 67 of the reflecting mirror 66.

The inventor has observed the effect of the shielding plate 65 of the present invention. The inventor prepared the magneto-optical disk drive 14 as a specific example of the invention and a magneto-optical disk drive according to a comparative example. The aforementioned mobile unit 32 was employed in the magneto-optical disk drive 14 of the specific example. The shielding plate 65 was set at the inner end of the horizontal hollow space 63. No shielding plate 65 was set in a mobile unit according to the comparative example. The luminous energy of the laser beam 46 returning from the MO disk 27 was observed for the magneto-optical disk drives. A so-called acceleration test was employed. Conditions were set tougher than the normal conditions in the acceleration test. The luminous energy was measured at equal time intervals in the acceleration test. The luminous energy was specified as a ratio to the luminous energy 100[%] at the starting time of the test. The acceleration test introduces the time running approximately 320 times faster than the normal.

As shown in FIG. 8, the specific example reached the luminous energy of 60[%] in approximately 1.5 times longer period than the comparative example. It has been confirmed that the shielding plate 65 enables a reduction in the amount of dust cumulating on the reflecting surface 67 of the reflecting mirror 66. A sufficient luminous energy was maintained for a longer period of time. The performance of the read/write operation can thus be maintained for a longer period of time.

What is claimed is:

1. An optical recording medium drive comprising:
a support body defining a hollow space along an inside surface of the support body, said hollow space having an inner end and an outer end that defines an optical opening;
a reflecting mirror supported on the support body, said reflecting mirror opposed to the inner end of the hollow space; and
a transparent shielding plate screening the hollow space at a position distanced from the optical opening.

2. The optical recording medium drive according to claim 1, further comprising:
a support member located within a space surrounded by the inside surface of the support body at a position distanced from the inside surface of the support body;
an objective lens supported on the support member, said objective lens opposed to the reflecting mirror within the space; and
a leaf spring coupling the support member to the support body for a movement relative to the support body.

3. The optical recording medium drive according to claim 1, further comprising:
an optical recording medium;
a rail extending in parallel with a surface of the optical recording medium; and
a through hole defined in the support body for receiving the rail, said through hole forming a sliding bearing.

4. An optical pickup comprising:
a support body defining a hollow space along an inside surface of the support body, said hollow space having an inner end and an outer end that defines an optical opening;
a reflecting mirror supported on the support body, said reflecting mirror opposed to the inner end of the hollow space; and
a transparent shielding plate screening the hollow space at a position distanced from the optical opening.

5. The optical pickup according to claim 4, further comprising:
a support member located within a space surrounded by the inside surface of the support body at a position distanced from the inside surface of the support body;
an objective lens supported on the support member, said objective lens opposed to the reflecting mirror within the space; and
a leaf spring coupling the support member to the support body for a movement relative to the support body.

6. The optical pickup according to claim 4, wherein the support body defines a through hole for receiving a rail extending straight, said through hole forming a sliding bearing.
